(19) United States
(12) Patent Application Publication
(10) Pub. No.: US 2014/0149855 A1
(43) Pub. Date: May 29, 2014

(54) Character Segmenting Method and Apparatus for Web Page Pictures

(71) Applicant: Jie Liang, Beijing (CN)

(72) Inventor: Jie Liang, Beijing (CN)

(73) Assignee: UC Mobile Limited, Beijing (CN)

(21) Appl. No.: 13/880,977

(22) PCT Filed: Oct. 19, 2011
(86) PCT No.: PCT/CN11/80968

§ 371 Date: May 31, 2013

(30) Foreign Application Priority Data
Oct. 21, 2010 (CN) 201010521691.1

(51) Int. Cl. G06F 17/21

(52) U.S. Cl. CPC G06F 17/212
USPC 715/252

(57) ABSTRACT

The present invention provides a character segmenting method for web page pictures comprising: scanning row by to a web page picture and demarcating in units of rows the picture into alternating first blank regions and first content regions; segmenting the demarcated first content regions from the web page picture; scanning column by column each of the segmented first content regions, and demarcating in units of columns each of the first content regions into alternating second blank regions and second content regions; and segmenting the second content regions and the second blank regions according to the pixel coordinates of the second blank regions so as to take the segmented second content regions as individual characters in the first content regions determined as fiction pictures. By applying the method, a web page picture can be segmented into individual characters, and the individual characters can be rearranged to the screen size of a mobile terminal for appropriate display on the screen thereof.

### FIELD OF THE INVENTION

The present invention relates to the field of web page browsing, and more specifically, to a character segmenting method and apparatus for W e b page pictures.

### BACKGROUND

With the progress of communication technology, it is becoming a trend to log on fiction websites and browse the contexts of fictions published thereon h using mobile terminals. Usually, many fiction websites display the contexts., especially some of the VIP chapters, of fictions in picture format, thus hindering readers from copying the contexts of the fictions for the purpose of copyright protection thereof.

### SUMMARY

### Technical Problem

In general, the contents of fiction websites are arranged for being displayed in personal computers (PC), therefore, the picture format used for displaying the contents is specifically appropriate for PC screen display. When a fiction website is logged on and the web pages thereof are browsed by using a mobile terminal, the web pages are difficult to be displayed on the small screen of the mobile terminal as they are on the screen of a PC due to the large screen oriented picture format used for the web pages. In this situation, if the fiction pictures are zoomed out to the screen size of the mobile terminal, the characters in the pictures will be too small to read, and if the fiction pictures are displayed in their original format, they have to be repeatedly moved to the right and left directions in the window of the mobile terminal during the user's reading, which makes the reading inconvenient.

In light of above mentioned problem, the contents of the web page pictures of a fiction website need to be adapted, for example, to be rearranged, to the screen size of a mobile terminal when they are browsed by using the mobile terminal.

Since the rearrangement for the fiction contexts takes characters as fundamental units, the web page pictures need to be segmented into characters before the contents thereof are rearranged.

### Technical Solution

In consideration of the above discussion, the present invention provides a character segmenting method and apparatus for web page pictures, wherein web page pictures containing fiction contexts can be segmented into individual characters and the obtained individual characters can be rearranged to the screen size of a mobile terminal so that the fiction contexts can be appropriately displayed on the screen of the mobile terminal.

According to one aspect or the present invention, there is provided a character segmenting method for web page pictures, comprising scanning row by row the pixels of an obtained web page picture and demarcating in units of rows the web page picture into first blank regions each consisting of continuous blank pixel rows and first content regions each consisting of continuous content pixel rows; segmenting the demarcated first content regions from the obtained web page picture; scanning column by column the pixels of each of the segmented first content regions, and demarcating in units of columns each of the segmented first content regions into second blank regions each consisting of continuous blank pixel columns and second content regions each consisting of continous content pixel columns; and segmenting the second content regions and the second blank regions according to the pixel coordinates of the second blank regions and taking the segmented second content regions as individual characters in the first content regions.

Furthermore, in one or more embodiments, the step of segmenting the demarcated first content regions from the obtained web page picture may further comprise: determining whether the first content regions arc fiction picture or not according to the heights of the demarcated first content regions and the height characteristic of character rows in fiction pictures; and when a first content region is determined to be a fiction picture, segmenting the first content region from the obtained web page picture with the center lines of two adjacent blank regions thereof as boundaries.

Furthermore, in one or more embodiments, the step of determining whether the first content regions are fiction pictures or not may comprise: calculating the mean height of the first content regions; and when the calculated mean height of the first content regions falls within a first threshold range, determining that the first content regions are a fiction picture.

Furthermore, in one or more embodiment the step of determining whether the first content regions are fiction pictures or not may further comprise: calculating the height standard deviation of the first content regions; and when the mean height of the first content regions falls within the first threshold range and the ratio of the height standard deviation to the mean height of the first content regions is less than a second threshold value, determining that the first content regions are a fiction picture.

Furthermore, the step of segmenting the second content regions and the second blank regions according to the pixel coordinates of the second blank regions may further comprise: determining the maximal width of the second content regions according to the pixel coordinates of the demarcated second blank regions; determining the character segmenting points of the second content regions by using the determined maximal width of the second content regions and the endpoint coordinates of the second blank regions; and segmenting the second content regions and the second blank regions by using the determined character segmenting points of the second blank regions so as to take the segmented second content regions as individual characters in the first content regions that are determined as fiction pictures.

Furthermore, while the pixels of an obtained web page picture are scanned row by row or column by column, it is possible to perform to watermark filtering treatment on the web page picture according to the pixel grey values thereof.

According to another aspect of the present invention, there is provided a character segmenting apparatus for web page pictures, comprising a first demarcating unit, configured for scanning row by row the pixels of an obtained web page picture and demarcating in units of rows the web page picture into first blank regions each consisting of continuous blank pixel rows and first content regions each consisting of continuous content pixel rows: a first segmenting unit, configured for segmenting the demarcated first content regions from the obtained web page picture; a second demarcating unit, configured for scanning column by column the pixels of each of the segmented first content regions, and demarcating in units of columns each of the segmented first content regions into second blank regions each consisting of continuous blank pixel columns and second content regions each consisting of continuous content pixel columns; and a second segmenting unit, configured for segmenting the second content regions and the second blank regions according to the pixel coordinates of the second blank regions and taking the segmented second content regions as individual characters in the first content regions.

Furthermore, in one or more embodiments, the first segmenting unit may further comprise: a first judging unit, configured for determining whether the first content regions are fiction picture or not according to the heights of the demarcated first content regions and the height characteristic of character rows in fiction pictures: and a first cutting unit, when a first content region is determined to he a fiction picture, cutting the first content region from the obtained web page picture with the center lines of two adjacent blank regions thereof as boundaries.

Furthermore, in one example, the first segmenting unit may further comprise: a calculating unit, configured for calculating the mean heights of the first content regions, and when the calculated mean height of the first content regions falls within a first threshold range, the first judging unit determines that the first content regions are a fiction picture.

Furthermore, in another example, the calculating unit may further calculate the height standard deviation of the first content regions, and only when the mean height of the first content regions falls within the first threshold range and the ratio of the height standard deviation to the mean height of the first content regions is less than a second threshold value, the first judging unit determines that the first content regions are a fiction picture.

Furthermore, in one or more embodiments, the second segmenting unit may comprise a first determining unit, configured for determining the maximal width of the second content regions according to the pixel coordinates of the demarcated second blank regions: a second determining unit, configured for determining the character segmenting points of the second content regions by using the determined maximal width of the second content regions and the endpoint coordinates of the second blank regions; and a second cutting unit, configured for cutting the second content regions and the second blank regions by using the determined character segmenting points of the second blank regions so as to take the segmented second content regions as individual characters in the first content regions that are determined as fiction pictures.

Furthermore, the character segmenting apparatus may further comprise a watermark filtering unit, while the pixels of an obtained web page picture are scanned row by row or column by column, the water filtering unit is used to perform a watermark filtering treatment on the web page picture according to the pixel grey values thereof.

According to still another aspect of the present invention, there is provided a mobile terminal comprising the above mentioned character segmenting apparatus for web page pictures.

According to yet still another aspect of the present invention, there is provided a server comprising the above mentioned character segmenting apparatus for web page pictures.

### Advantageous Effects

With above described character segmenting method and apparatus, it is possible to segment a web page picture into individual characters, and rearrange fiction contexts to the screen size of a mobile terminal by using the segmented individual characters so as to appropriately display the fiction contexts on the screen of the mobile terminal.

In addition, it is possible to improve the accuracy of demarcating the blank regions and the content regions, and thus improve the accuracy of the character segmenting by performing a watermark filtering treatment on the web page picture.

In order to realize the above described and other related purposes one or more aspects of the present invention comprise the features described in details in the following contexts and specifically indicated in the claims. The following description and the accompanying drawings will illustrate in details some of the exemplified aspects of the present invention. However, those indicated in the aspects are only some of ways in which the principles of the present invention can be applied. In addition, the present invention is intended to include all the aspects and the equivalents thereof.

### BRIEF DESCRIPTION OF THE DRAWINGS

The other objectives and results of the present invention will become apparent and easily understood from the following description given in conjunction with the accompanying drawings and the contents of the claims and with the full understanding of the present invention. In the drawings,

FIG. 1 is a flow chart shot in,g a character segmenting method for web page pictures according to one embodiment of the present invention;

FIG. 2 is an exemplified flow chart showing the process of segmenting the first content regions of FIG. 1;

FIG. 3 is an exemplified flow chart showing the process of segmenting the second content regions of FIG. 1;

FIG. 4 is a schematic block diagram showing a character segmenting apparatus for web page pictures according to one embodiment of the present invention;

FIG. 5 is a schematic block diagram showing an exemplified structure of the first segmenting unit of FIG. 4;

FIG. 6 is a schematic block diagram showing an amplified structure of the second segmenting unit of FIG. 4;

FIG. 7 is a schematic block diagram showing a mobile terminal comprising the character segmenting apparatus according to the present invention; and

FIG. 8 is a schematic block diagram showing a server comprising the character segmenting apparatus according to the present invention.

Like reference numerals indicate like features or functions in all drawings.

### DETAILED DESCRIPTION

In the following description, for purposes of explanation, numerous specific details are set forth in order to provide a through understanding of one or more embodiments. It may be evident, however, that the embodiments may be practiced without these specific details. In other instances, well-known structures and devices are shown in block diagram form in order to facilitate describing one or more embodiments.

The embodiments of the present invention will be described in details with reference to the accompanying drawings.

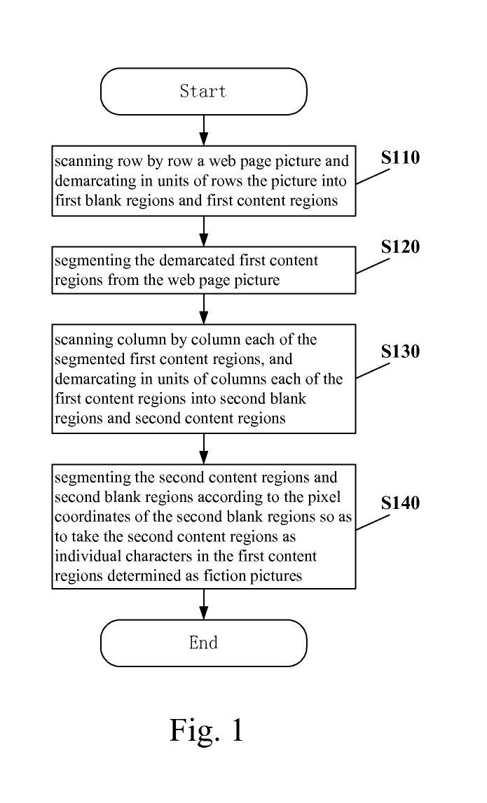

FIG. 1 is a flow chart showing a character segmenting, method for web page pictures according to one embodiment of the present invention.

As shown in FIG. 1, first, in step S110, the pixels of an web page picture obtained from an objective website (for example, a fiction website) are scanned row by row, and the web page picture is demarcated in units of rows into a plurality of first blank regions each consisting of continuous blank pixel rows and a plurality of first content regions each consisting of continuous content pixel rows, wherein the first blank regions and the first content regions are alternately arranged, for example, a first blank region may consist of one or more continuous blank pixel rows, and a first content region may consist of one or more continuous content pixel rows.

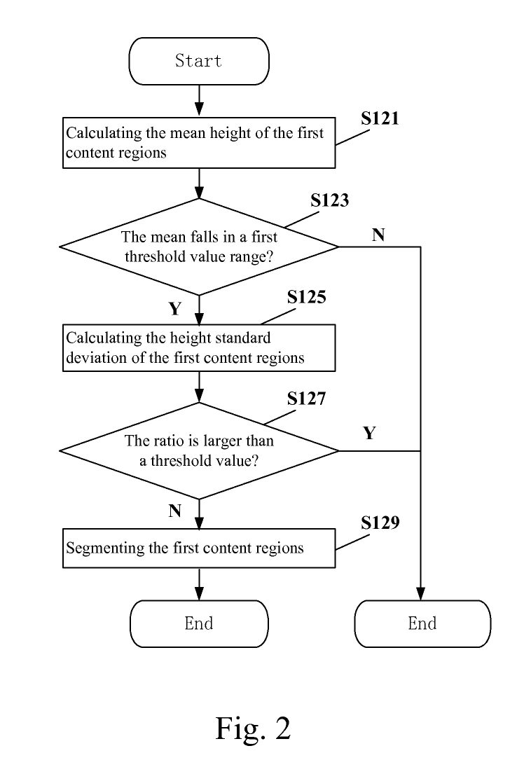

Then, in step S120, the demarcated first content regions are segmented from the obtained web page picture. Specifically, a fiction picture is a web page picture consisting of rows of characters, wherein a blank region is sandwiched between every two adjacent character rows. As for a common fiction picture, the heights of the character rows are usually in a range of 10-30 pixels (i.e. the height characteristic of a character w in a fiction picture), and the mean value of the character rows will fall in the same range. Furthermore, the heights of the character rows in a fiction picture are roughly the same, and the ratio of the standard deviation to the mean thereof is very small (usually less than 1). Thus, preferably, the mean height (and further the ratio of the height standard deviation to the mean height) of the first content regions may be calculated according to the heights of the demarcated first content regions, the first extent regions may be determined according to the calculated mean height (or the ratio of the height standard deviation to the mean height) and the height characteristic of the character rows of a fiction picture, and all the first content regions that are determined to be as fiction picture are segmented. The specific process of determining the first content regions and segmenting those that are determined to be a fiction picture will be described with reference to FIG. 2.

FIG. 2 is an exemplified flow chart showing the process of segmenting the first content regions of FIG. 2.

As shown in FIG. 2, first, in step S121, the mean height of the demarcated first content regions is calculated. Then, in step S123, it is determined whether the calculated mean height of the first content regions falls within a first threshold range or not, wherein, the first threshold range, which is also referred to as the height characteristic of the character rows in a fiction picture, may be a range of for example 10 to 30 pixels.

If the calculated mean height of the first content regions doesn't fall within the first threshold range, then it is determined that the first content regions are not a fiction picture, and thus they will not be treated if the calculated meal/ height of the first content regions falls within the first threshold range, then proceed to step S125. In step S125, the height standard deviation of the first content regions is further calculated, and then in step S127, it is determined whether the ratio of the height standard deviation to the mean height of the first content regions is less than a second threshold value, which usually is for example 1.

If the ratio is larger than the second threshold value, then it is determined that the first content regions are not a fiction picture, and thus they will not be treated. If the ratio is less than the second threshold value, i.e. it is determined that the first content regions are a fiction picture, then in step S129, the first content regions are segmented with the center lines of two adjacent blank regions thereof as boundaries.

After all the first content regions that are determined to he a fiction figure are segmented from the demarcated first content regions, in step S130, each of the segmented first content regions is scanned column by column, and demarcated in units of columns into a plurality of alternately arranged second blank regions and second content regions, for example, a first content region is segmented into k second content regions and k+1 second blank regions, wherein each of the second blank regions consists of one or more continuous blank pixel columns and each of the second content regions consists of one or more continuous content pixel columns.

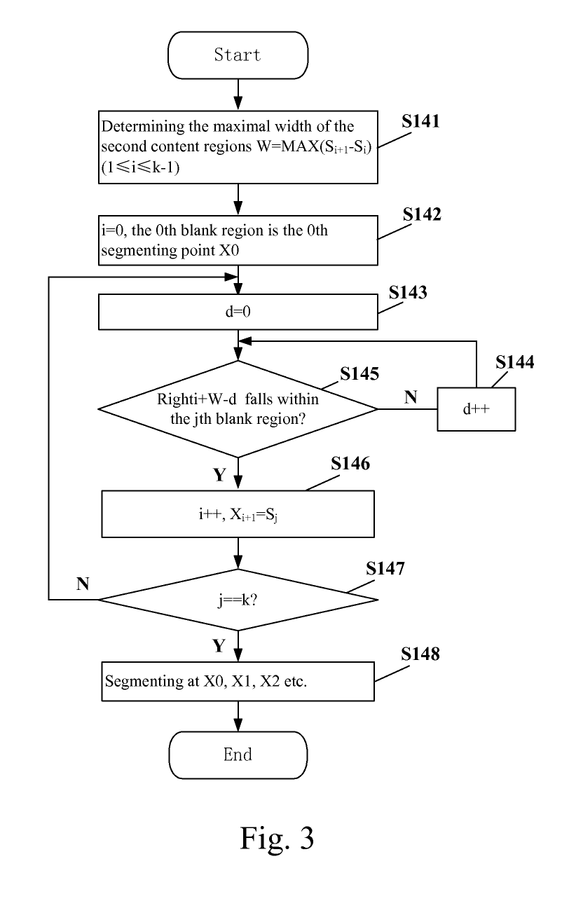

Then, in step S140, the second content regions and the second blank regions are segmented according to the pixel coordinates of the second blank regions, and the segmented second content regions are taken as individual characters in the first content regions that are determined to be a fiction picture. FIG. 3 is an exemplified flow chart showing the process of segmenting the second content regions of FIG 1.

As shown in FIG. 3, first, in step S141, according to the pixel coordinates of the demarcated second blank regions, for example, the endpoint coordinates or the middle point coordinates of the second blank regions, wherein the middle point coordinate S is adopted in this example, i represents the serial number of the second blank regions and ranges from 0 to k, the maximal width W=MAX(Sᵢ₊₁-Sᵢ) of the second content regions is determined, wherein 1≦i≦k−1.

The character segmenting points of the second content regions are determined by using the determined maximal width W of the second content regions and the endpoint coordinates of the second blank regions (i.e. the right endpoint coordinates in this example). A detailed process is shown in step S142 to step S147. In step S142, i is set as i=0, and the middle point X0 of the zeroth blank region is taken as the zeroth character segmenting point In step S143, the initial value of variable d is set as d=0. In step S145, the sum of the right endpoint coordinate Rightᵢ of the currently segmented blank region and the maximal width W is calculated, and it is determined whether the pixel Rightᵢ+W-d fails within the jth blank region, wherein the coordinates of the right and left endpoints of the jth blank region can be obtained from the mobile terminal. If the pixel Rightᵢ+W-d doesn't fall within the jth blank region then in step S144, the variable d increases by 1, and return to step S145 to perform circulation. If the pixel Right₁+W-d falls within the jth blank region, then proceed to step SI 46, and take the middle point of the jth blank region as the right segmenting point of the ith character, i.e. Xᵢ₊₁=Sⱼ, and as the segmenting point of the current character, and i increases by 1. Then, in step S147, it is determined whether j==k or not. If j==k, then proceed to step S148, and in step S148, the second content regions and the second blank regions are segmented by using the determined character segmenting points and the segmented second content regions are taken as individual characters in the first content regions that are determined as fiction pictures; otherwise, return to step S143.

In addition, some websites put watermarks on the pictures, which makes a blank region not highly blank, therefore when a web page picture is demarcated into blank regions and content regions, some watermark containing blank regions may be determined as content regions, causing that the blank regions cannot be accurately distinguished from the content regions. Thus, preferably, while the pixels of a web page picture obtained from an objective website are scanned row by row or column by column, a watermark filtering treatment may be performed on the web page picture according to the pixel grey values of the scanned web page picture.

Specifically, as for a watermark containing fiction picture the watermark filtering treatment may be performed by setting a threshold value (for example, a gray scale of 50%), since the gray scale of the watermark is usually relatively low, while that of the characters is relatively high. In this situation, if the gray scale of the pixels of the scanned web page picture is larger than the threshold value, then the pixels may be determined as content pixels and if the gray scale of the pixels of the scanned web page picture is less than the threshold value, then the pixels may be determined as blank pixels. Herein, the gray scale Gray is the complement of the brightness 1, i.e. Gray=1−1. A commonly used calculation formula for brightness may be 1=0.299*R+0.587*G+0.114*B.

In addition, in case that a website utilizes a color watermark, the calculation formula for brightness may become 1=MAX(R, G, B), and thus that for the gray scale may become Gray=1−MAX(R, G, B), in order to effectively filter the color watermark.

By performing the watermark filtering treatment on the web page picture, the watermark containing blank regions can be prevented from being determined as content regions, thereby the accuracy of distinguishing the blank regions from the content regions arid thus the accuracy of character segmenting may be improved.

It should be noted that the above described method may be realized on the browser of a mobile terminal or on a server.

In case the method is realized on the browser of a mobile terminal, the browser usually has a powerful performance. In case the method is realized on a server, the browser of a mobile terminal needs to send the URI, of a website to be browsed to the server, and the server obtains web page data from the website, performs character segmenting on it, and sends the segmented characters to the browser of the mobile terminal after finishing the character segmenting.

The character segmenting method for web page pictures according to the present invention has been described with reference to FIG. 1 to FIG. 3. The above character segmenting method for web page pictures according to the present invention may be realized through software or through hardware, or through the combination thereof.

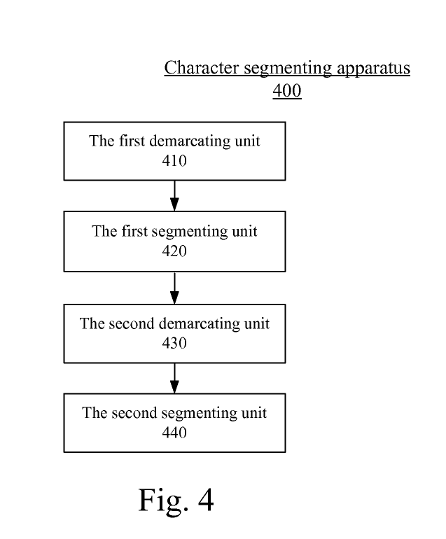

FIG. 4 is a schematic block diagram showing a character segmenting apparatus 400 for web page pictures according to one embodiment of the present invention. As shown in FIG. 4, the character segmenting apparatus 400 comprises a first demarcating unit 410, a first segmenting unit 420, a second demarcating unit 430 and a second segmenting unit 440.

After a web page picture is obtained from an objective website (for example, a fiction website), the first demarcating unit 410 scans row by row the pixels of the obtained web page picture and demarcates in units of rows the web page picture into a plurality⁻ of alternately arranged first blank regions each consisting of continuous blank pixel rows and first content regions each consisting of continuous content pixel rows, for example, each of the first blank regions may consist of one or more continuous blank pixel rows, and each of the first content regions may consist of one or more continuous content pixel rows.

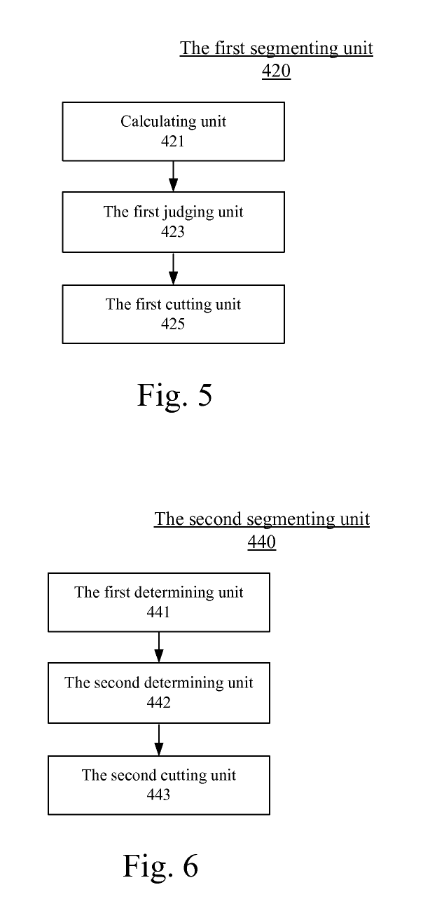

Then, the first segmenting unit 420 segments the demarcated first content regions from the obtained web page picture. Preferably, the first segmenting unit 420 may segment all the first content regions that are determined to be a fiction picture from the obtained web page picture according to the heights of the demarcated first content regions and the height characteristic of the character rows of a fiction picture. The details of the first segmenting unit 420 will be described later with reference to FIG. 5.

After the first content regions determined to be a fiction picture are segmented, the second demarcating unit 430 scans column by column the pixels of each of the segmented first content regions and demarcates in units of columns the first content regions into a plurality of alternately arranged second blank regions each consisting of continuous blank pixel columns and second content regions each consisting of continuous content pixel columns, for example, each of the second blank regions may consist of one or more continuous blank pixel columns, and each of the second content regions may consist of one or more continuous content pixel columns.

After the plurality of second content regions and second blank regions are demarcated, the second segmenting unit 440 segments the second content regions and the second blank regions according to the pixel coordinates of the second blank regions so as to take the segmented second content regions as individual characters in the first content regions determined to he a fiction picture. The details of the second segmenting unit 440 will he described later with reference to FIG. 6.

In addition, preferably, when dealing with watermarks on a web page picture from an objective website, the character segmenting apparatus 400 may further comprise a watermark filtering unit (not shown), while the pixels of an web page picture are scanned row by row or column by column, the water filtering unit is used to perform a watermark filtering treatment on the web page picture according to the pixel grey values of the scanned web page picture.

FIG. 5 is a schematic block diagram showing an exemplified structure of the first segmenting unit 420 of FIG. 4 As shown in FIG. 5, the first segmenting unit 420 may comprise a calculating unit 421, a first judging unit 423 and a first cutting unit 425.

The calculating unit 421 calculates the mean height of the segmented first content regions. When the calculated mean height of the first content regions falls within a first threshold range the first judging unit 423 determines that the first content regions are a fiction picture. When a first content region is a fiction picture, the first cutting unit 425 cutting the first content region with the center lines of two adjacent blank regions thereof as boundaries.

Furthermore optionally, the calculating unit 421 may further calculate the height standard deviation of the segmented first content regions, and when the calculated moan height of the first content regions fails within the first threshold range and the ratio of the height standard deviation to the mean height is less than a second threshold value, the first judging unit 423 determines that the first content region is a fiction picture.

Herein, it should he noted that the calculating unit 421 may be put either outside the first judging unit 423, or inside the first judging unit 423.

FIG. 6 is a schematic block diagram showing an exemplified structure of the second segmenting unit of FIG. 4. As shown in FIG. 6, the second segmenting unit 440 may comprise a first determining unit 441, a second determining unit 442 and a second cutting unit 443.

The first determining unit 441 determines the maximal width of the second content regions according to the pixel coordinates of the demarcated second blank regions. The second determining unit 442 determines the character segmenting points of the second content regions by using the determined maximal width of the second content regions and the endpoint coordinates (the right endpoint coordinates in this example) of the second blank regions. After all the character segmenting points are determined, the second cutting unit 443 cutting the second content regions and the second blank regions by using the determined character segmenting points so as to take the segmented second content regions as individual characters in the first content regions that are determined as fiction pictures.

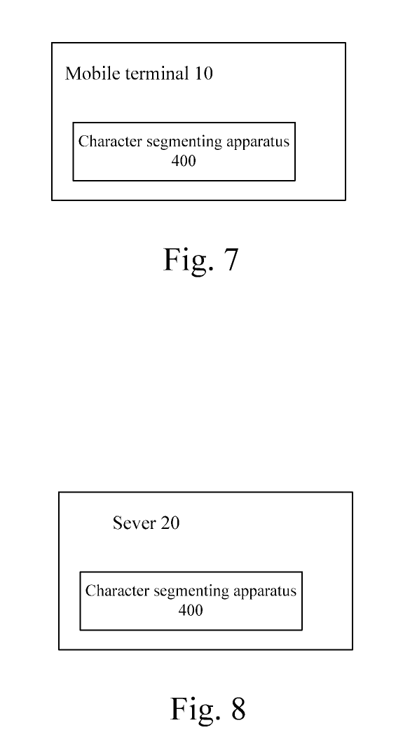

FIG. 7 is a schematic block diagram showing a mobile terminal 10 comprising the character segmenting apparatus 400 according to the present invention. The character segmenting apparatus 400 included in the mobile terminal of FIG. 7 may comprise various modifications of the embodiments of the present invention.

FIG. 8 is a schematic block diagram showing a server 20 comprising the character segmenting apparatus 400 according to the present invention. The character segmenting apparatus 400 included in the server of FIG. 8 may comprise various modifications of the embodiments of the present invention.

Typically, the mobile terminal according to the present invention may he a terminal device that can browse web pages, for example, a mobile phone, a PDA and so on, therefore, the protection scope of the present invention should not he limited to some specific mobile terminals.

In addition, the method according to the present invention may be realized as computer programs executed by CPU. When the computer programs are executed by CPU, the above mentioned functions defined in the method according to the present invention will be realized.

In addition, the above mentioned steps of the method and units of the apparatus may also be realized by using a controller or processor and a computer readable memory device for storing computer programs that can make the controller or processor realize above mentioned steps or unit functions.

Furthermore, it should he noted that the computer readable memory device (for example, a memory) mentioned herein may he a volatile memory or a non-volatile memory, or may comprise both. As an unrestricted example, the non-volatile memory may comprise read-only memory (ROM), programmable read-only memory (PROM), electrically programmable read-only memory (EPROM), electrically erasable programmable read-only memory (EEPROM), or flash memory. The volatile memory may comprise random access memory (RAM), which can act as an external cache memory. As an unrestricted example. RAM may be realized in various ways, for example, synchronous RAM, dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DRRAM). The disclosed memory devices are intended to comprise but not limited to these and other appropriate memories.

It will be apparent for those skilled in the art that various exemplified logic blocks, modules, circuits and algorithm steps described in combination with the disclosure may be realized as electronic hardware, computer software or the combination thereof. In order to clearly illustrate the interchangeability between hardware and software, it has been generally described with respect to the functions of various exemplified assemblies, blocks, modules, circuits and steps. Whether the functions are realized with hardware or software depends on specific, applications and the design constraints exerted on the whole system. Those skilled in the art may realize the functions in various ways as far as each specific application is concerned, which, however, should not be construed as departing from the scope of the present invention.

Various exemplified logic blocks, modules, and circuits described in combination with the disclosure may be realized by using the following members configured for performing the herein described functions: universal processor, digital signal processor (DSP), application specific integrated circuit (ASIC), field programmable gate array (EPGA) or other programmable logic devices, discrete gate or transistor logic, discrete hardware modules or the combination of any of the devices. The universal processor may be a microprocessor, but alternatively, the processor may be any traditional processor, controller, micro-controller or state machine. The processor may also be realized as a combination of computing devices, for example, a combination of DSP and microprocessor, multiple microprocessors, one or more DSP combining microprocessor core, or any other similar configurations.

The steps of the method or algorithm described in combination with the disclosure may be directly combined in a hardware unit, or in a software module executed by a processor or in the combination thereof. The software module may be stored in a RAM, a flash memory, a ROM, an EPROM, an EEPROM, a register, a hard disk, a mobile hard disk, a CD-ROM or any other store media known to those skilled in the art. An exemplified store medium is connected to a processor so that the processor may read from or write into the medium. Alternatively, the store medium may be integrated with the processor. The processor and the store medium may be embedded in an ASIC. The ASIC may be embedded in a user terminal. Alternatively, the processor and the store medium may he separately embedded in a user terminal.

Although the exemplified embodiments of the present invention have been shown in the contexts disclosed above, it should be noted that various modifications and variations may be applied thereto without departing from the scope of the invention defined by the claims. The functions, steps and/or actions of the process claims according to herein described embodiments are not necessarily performed in any specific, sequence. In addition, although the elements of the present invention may be described or required in a singular form, they may appear in a plural form, unless otherwise stated.

While the present invention has been disclosed with reference to preferred embodiments described in details, those skilled in the art should understand that various modifications may be made to the character segmenting method and apparatus for web page pictures according to the present invention without departing from the contents of the present invention. Therefore, the scope of the present invention should be defined by contents of the appended claims.

1. A character segmenting method for web page pictures, comprising:
scanning row by row the pixels of an obtained web page picture and demarcating in units of rows the web page picture into first blank regions each consisting of continuous blank pixel rows and first content regions each consisting of continuous content pixel rows;
segmenting the demarcated first content regions from the obtained web page picture;
scanning column by column the pixels of each of the segmented first content regions, and demarcating in units of columns each of the first content regions into second blank regions each consisting of continuous blank pixel columns and second content regions each consisting of continuous content pixel columns; and
segmenting the second content regions and the second blank regions according to the pixel coordinates of the second blank regions so as to take the segmented second content regions as individual characters in the first content regions.

2. The method of claim 1, wherein the step of segmenting the demarcated first content regions from the obtained web page picture further comprises:
determining whether the first content regions are fiction picture or not according to the heights of the demarcated first content regions and the height characteristic of character rows in fiction pictures; and
when a first content region is determined to be a fiction picture, segmenting the first content region from the obtained web page picture with the center lines of two adjacent blank regions thereof as boundaries.

3. The method of claim 2, wherein the step of determining whether the first content regions are fiction pictures or not further comprises:
calculating the mean height of the first content regions; and
when the calculated mean height of the first content regions falls within a first threshold range, determining that the first content regions are a fiction picture.

4. The method of claim 3, wherein the step of determining whether the first content regions are fiction pictures or not further comprises:
calculating the height standard deviation of the first content regions; and
when the mean height of the first content regions falls within the first threshold range and the ratio of the height standard deviation to the mean height of the first content regions is less than a second threshold value, determining that the first content regions are a fiction picture.

5. The method of claim 1, wherein the step of segmenting the second content regions and the second blank regions according to the pixel coordinates of the second blank regions further comprises:
determining the maximal width of the second content regions according to the pixel coordinates of the demarcated second blank regions;
determining the character segmenting points of the second content regions by using the determined maximal width of the second content regions and the endpoint coordinates of the second blank regions; and
segmenting the second content regions and the second blank regions by using the determined character segmenting points of the second blank regions so as to take the segmented second content regions as individual characters in the first content regions that are determined as fiction pictures.

6. The method of claim 1, wherein when the pixels of an obtained web page picture are scanned row by row or column by column, the method further comprises:
performing a watermark filtering treatment on the web page picture according to the pixel grey values thereof.

7. A character segmenting apparatus for web page pictures, comprising:
a first demarcating unit, configured for scanning row by row the pixels of an obtained web page picture and demarcating in units of rows the web page picture into first blank regions each consisting of continuous blank pixel rows and first content regions each consisting of continuous content pixel rows;
a first segmenting unit, configured for segmenting the demarcated first content regions from the obtained web page picture;
a second demarcating unit, configured for scanning column by column the pixels of each of the segmented first content regions, and demarcating in units of columns each of the segmented first content regions into second blank regions each consisting of continuous blank pixel columns and second content regions each consisting of continuous content pixel columns; and
a second segmenting unit, configured for segmenting the second content regions and the second blank regions according to the pixel coordinates of the second blank regions so as to take the segmented second content regions as individual characters in the first content regions.

8. The apparatus of claim 7, wherein the first segmenting unit further comprises:
a first judging unit, configured for determining whether the first content regions are fiction picture or not according to the heights of the demarcated first content regions and the height characteristic of character rows in fiction pictures; and
a first cutting unit, when a first content region is determined to be a fiction picture, cutting the first content region from the obtained web page picture with the center lines of two adjacent blank regions thereof as boundaries.

9. The apparatus of claim 8, wherein the first segmenting unit further comprises:
a calculating unit, configured for calculating the mean heights of the first content regions; and
when the calculated mean height of the first content regions falls within a first threshold range, the first judging unit determines that the first content regions are a fiction picture.

10. The apparatus of claim 9, wherein the calculating unit further calculates the height standard deviation of the first content regions; and
when the mean height of the first content regions falls within the first threshold range and the ratio of the height standard deviation to the mean height of the first content regions is less than a second threshold value, the first judging unit determines that the first content regions are a fiction picture.

11. The apparatus of claim 7, wherein the second segmenting unit further comprises:
a first determining unit, configured for determining the maximal width of the second content regions according to the pixel coordinates of the demarcated second blank regions;
a second determining unit, configured for determining the character segmenting points of the second content regions by using the determined maximal width of the second content regions and the endpoint coordinates of the second blank regions; and
a second cutting unit, configured for cutting the second content regions and the second blank regions by using the determined character segmenting points of the second blank regions so as to take the segmented second content regions as individual characters in the first content regions that are determined as fiction pictures.

12. The apparatus of claim 7, further comprising:
a watermark filtering unit, wherein when the pixels of an obtained web page picture are scanned row by row or column by column, the water filtering unit is used to perform a watermark filtering treatment on the web page picture according to the pixel grey values thereof.

13. A mobile terminal, comprising the character segmenting apparatus for web page pictures of claim 7.

14. A server, comprising the character segmenting apparatus for web page pictures of claim 7.
